(19) United States
(12) Patent Application Publication
(10) Pub. No.: US 2024/0193615 A1
(43) Pub. Date: Jun. 13, 2024

(54) AFTER-MARKET SERVICE PROCESS DIGITIZATION

(71) Applicant: Delaware Capital Formation, Inc., Wilmington, DE (US)

(72) Inventors: Prem Swaroop, Lexington, MA (US); Bodhayan Dev, Sturbridge, MA (US); Atish P. Kamble, Acton, MA (US); Girish Juneja, Lexington, MA (US); Jonah Somers, Watertown, MA (US)

(21) Appl. No.: 18/287,624

(22) PCT Filed: Apr. 20, 2022
(86) PCT No.: PCT/US2022/025466

§ 371 Date: Oct. 19, 2023

Related U.S. Application Data
(60) Provisional application No. 63/178,366, filed on Apr. 22, 2021.

(51) Int. Cl. G06Q 30/012

(52) U.S. Cl. CPC G06Q 30/012

(57) ABSTRACT

Among other things, techniques are described for an after-market service process digitization. Service data is obtained that is associated with at least one asset and comprises at least historical warranty data and current IoT data. Predictive analysis to generate an asset survival prediction is performed based on current data associated with a first asset and the service data. Troubleshooting data associated with the first asset from at least one knowledge data source is received. A warranty coverage metric is determined based on the asset survival prediction and the troubleshooting data, wherein the warranty coverage metric is calculated in real time according to the asset survival prediction and the troubleshooting data. The warranty coverage metric is transformed at a device into human-readable form.

### CROSS REFERENCE TO RELATED APPLICATION

The present application claims priority of U.S. Provisional Patent Application No. 63/178,366 filed on Apr. 22, 2021, entitled “After-Market Service Process Digitization,” which is herein incorporated by reference in its entirety.

### FIELD OF THE INVENTION

The present techniques relate to after-market service process digitization.

### BACKGROUND

An asset is a resource that provides value to its owner, with the expectation that it will provide a future benefit. In particular, resources are allocated to the asset to ensure a future benefit. For example, industrial assets, including industrial machines, production lines, industrial robots, and the like are operable to carry out various tasks in connection with the control of an industrial process or function, or the manufacture, transport, handling, or packaging of a product. Through their respective function, the assets benefit the owner. To ensure continued functionality through the life of the industrial assert, the owner can service or perform routine, corrective, or preventative maintenance on the industrial asset. Maintenance of the industrial asset may be associated with any number of costs.

### BRIEF DESCRIPTION OF THE DRAWINGS

FIG. 1 is a block diagram of an aftermarket service process digitization workflow.

FIG. 2 is an example of a Bayesian network that determines a most important service issue according to the present techniques.

FIG. 3 is an example of a page of the service excellence portal.

FIG. 4 is a series of screenshots from the troubleshooting mobile application.

FIG. 5 is a process flow diagram of a process for an after-market service process digitization.

FIG. 6 is a block diagram of an example computer system.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Trouble-shooting Workflow Traffic
3. Service Excellence Portal
4. Troubleshooting Mobile Application
5. After-Market Service Process Digitization

### General Overview

Industrial assets are serviced to ensure efficient operation of the assets. Generally, industrial assets include various equipment that support operations in any number of industries, such as oil & gas, water/wastewater, chemical, hygienic, transport, military, paint, coatings, and the like. The servicing of industrial assets is monitored. Existing and newly collected service data is analyzed to calculate an optimal extended warranty coverage metric. The analysis includes, but is not limited to, predictive analysis and troubleshooting analysis. Models associated with the predictive analysis vary according to the available service related data. The troubleshooting analysis is based on, at least in part, the predictive analysis. The analysis of the service data is adaptive by varying the models associated with the predictive analysis.

Some of the advantages of these techniques include a reduction in costs associated with after-market servicing of industrial assets. Time consumed by after-market servicing of industrial assets is also reduced. The present techniques are adaptive and can monitor the health of assets and also predict one or more warranty coverage metrics in a dynamic manner according to the current servicing of the assets. The present techniques enable continual monitoring of these assets and more efficient service calls by technicians using the troubleshooting mobile application.

### System Overview

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

After-market servicing of industrial assets can be a costly and time-consuming endeavor without proper information. Using data collected from a myriad of sources, the present techniques enable a suite of tools and platforms that can ingest any type of service-related data, document, or other information. In an embodiment, the present techniques use service-related data to determine warranty coverage metrics and facilitate a more efficient after-market spare parts servicing process. In particular, the present techniques enable revenue generation and cost savings in after-market spare parts servicing. For example, servicing an industrial asset refers to providing maintenance, repair, or tuning of the industrial asset. Maintenance may be, for example, routine, corrective, or preventative. Service is typically provided by a person skilled in providing maintenance, repair, or tuning of the industrial asset, such as a technician. In an example, a fleet manager coordinates the servicing of a plurality of assets by one or more technicians. For example, the fleet manager dispatches technicians to service assets. The fleet manager dispatches technicians to ensure that assets remain operable and any downtime is kept to a minimum. In an example, a sales manager coordinates the sale of warranties to cover service of an asset. As used herein, a warranty is a guarantee to service the asset for a predetermined period of time. The warranty is associated with a cost, and the cost varies according to a number of factors. These factors include, but are not limited to, a survivability/reliability analysis.

In an embodiment, the present techniques determine servicing strategies according to a plurality of inputs in distinct formats. Generally, the servicing strategy can include, for example, optimization of extended warranty contract, original equipment manufacturer (OEM) spare sales parts, preventative maintenance alerts, and troubleshooting chat bot-based applications. For example, the after-market service process digitization according to the present techniques can ingest multiple inputs in several formats, and the output can yield optimization of extended warranty contracts, OEM spare parts sales, and maintenance alerts. Additionally, the present techniques can enable troubleshooting via chat bot-based applications. In an embodiment, a service excellence portal and a troubleshooting mobile application enable optimization of warranty coverage metrics in real time based on dynamic asset data, including field returns from service technicians.

Accordingly, the present techniques enable a data-driven relationship between an owner of an asset and an asset servicer through a suite of service digitization solutions. Every component facilitates a better service relationship between the company and the customer through interactive troubleshooting, dashboard tracking, and service contract optimization. In an embodiment, an overall goal of the suite of tools is to optimize extended warranty pricing and save on warranty costs for the asset-owning company. Additionally, the present techniques enable sales managers to appropriately price extended warranty offerings to optimize customer experience and financial considerations. The collection of digitization processes is also flexible enough that a user could bring any other types of service data and the suite of applications could be adapted to extract value from it.

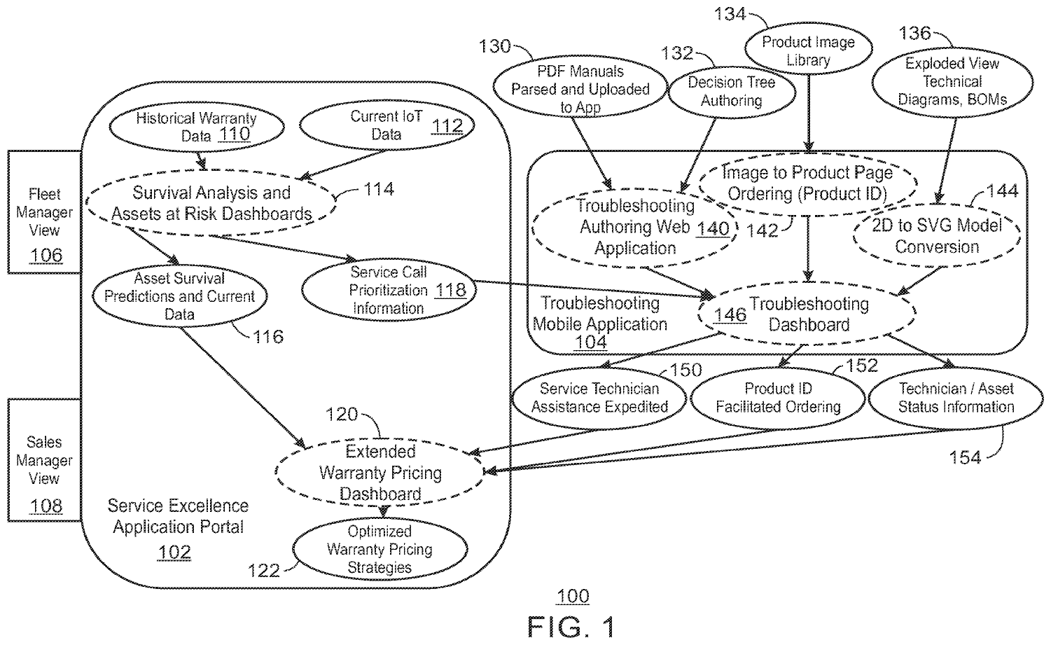

FIG. 1 is a block diagram of an aftermarket service process digitization system. In the block diagram of FIG. 1, data, information, strategies, data structures, and the like are illustrated using solid lines. The dashboards, processes, transformations, renderings, and the like are illustrated using dashed lines. Although particular processes and information are illustrated, the present techniques may include any number of processes and information. In the example of FIG. 1, a service excellence portal (SEP) 102 and troubleshooting mobile application 104 are illustrated. Generally, the SEP 102 is a platform that enables a number of views into a survivability/reliability analysis of one or more assets. The troubleshooting mobile application 104 enables access to general asset data for purposes of servicing (e.g., fixing/repairing) an asset. Simultaneously, the troubleshooting mobile application 104 stores asset data generated when servicing the asset. In an embodiment, the troubleshooting mobile application 104 determines a most pressing issue at a service location.

In an embodiment, the service excellence portal 102 and the troubleshooting mobile application 104 enable a suite of inter-related service-centric applications to ultimately optimize an after-market industrial servicing process through revenue growth and service cost reduction. For example, the present techniques optimize extended warranty contracts. A service tracking dashboard is provided to technicians with mobile part ordering and asset replacement functionality. Further, the present techniques enable coordination of available OEM spares and customer training with respect to the asset. In an example, the present techniques enable predictive maintenance alerts. The troubleshooting mobile application 104 may include a troubleshooting chat bot app. Additionally, the troubleshooting mobile application 104 includes service authorization, service team placement, and service partner evaluation. Moreover, the present techniques may enable engineering quality improvements.

Generally, the SEP 102 is a platform that enables a number of views into a survivability/reliability analysis of one or more assets. In the example of FIG. 1, a fleet manager view 106 and a sales manager view 108 of the service excellence portal 102 are illustrated. As used herein, the fleet manager view 106 is a view that includes survival analysis and assets at risk dashboards. In an embodiment, the survival analysis and assets at risk dashboards render a representation of asset data according to one or more key performance indicators (KPIs). In an embodiment, KPIs include survival curve estimations that calculate a predicted survivability of the assets. For example, parametric and non-parametric techniques are used to estimate a survivor curve that predicts survivability of assets. A non-parametric technique may be, for example, a Kaplan-Meier (KM) estimator. A parametric technique may be, for example, a Weibull distribution. An additional reliability model includes, for example, a semiparametric Cox proportional hazards model. The Cox proportional hazard model enables the inclusion of covariates of survival times. The Cox model is usually described as being semi-parametric because the component related to the predictor variables is parametric while the estimate of the survival function component is fully non-parametric and makes no assumption about the underlying distribution of the survival function. In another example, a Random Survival Forest model does not assume proportional hazards and has the flexibility to model survivor curves that are of dissimilar shapes for contrasting assets belonging to different clusters in terms of their usage, locations, sectors, model number and other characteristics.

In an embodiment, the survival analysis and assets at risk dashboards 114 render a representation of the asset health of one or more industrial assets. In an embodiment, the asset health includes an active state and the historical state of an asset. Asset health may include service data, such as mechanical system health across a company's assets. A sales manager view 108 includes a higher-level view of the strategies available to the sales manager for consumption (e.g., purchase) by a third party (e.g., customer.) For example, the sales manager view 108 includes a view of warranty coverage metrics (e.g., warranty pricing strategies), including optimized warranty pricing strategies. In an embodiment, the fleet manager view 106 includes renderings of information and data not available in the sales manager view 108.

In an embodiment, the SEP 102 is web-based. Resources associated with the SEP 102 include historical warranty data 110 and current internet of things (IOT) data 112. In an embodiment, warranty data includes information associated with asset quality and reliability. Warranty data includes claims data collected during the servicing of items under warranty, as well as supplementary data including production, marketing, and the like. In an embodiment, forecasting warranty claims enables an owner of the asset to allocate fiscal resources to warranty coverage. In an embodiment, historical warranty data 110 and current IoT data 112 are used to build the survival analysis and assets at risk dashboards 114. The survival analysis and assets at risk dashboards 114 are rendered by the SEP 102. In an example, the fleet manager observes the survival analysis and assets at risk dashboards 114 to evaluate the performance of the assets. Based on the survival analysis and assets at risk dashboards 114, the predictions for the asset survival are made, as well as a determination as to how to prioritize service calls.

In the example of FIG. 1, asset survival predictions and current data 116 are output by the survival analysis and assets at risk dashboards 114. Additionally, in the example of FIG. 1, service call prioritization information 118 is output by the survival analysis and assets at risk dashboards 114. The asset survival predictions and current data 116 is rendered by the extended warranty pricing dashboard 120. Additional output by the extended warranty pricing dashboard includes optimized warranty pricing strategies 122. In the example of FIG. 1, the extended warranty pricing dashboard 120 is rendered in a sales manager view 108.

In an example, the SEP 102 uses survivability/reliability analysis to assess which of the assets are at highest risk. Using the survivability/reliability probabilities, appropriate extended warranty pricing contracts for the assets are calculated. In an embodiment, the survivability/reliability probabilities are used to calculate an optimal warranty servicing frequency or preventative maintenance frequency duration. As a result, the SEP 102 converts warranty and service operations to a digital format. In an embodiment, industry best practices can be applied in real time. Additionally, the service excellence portal enables rapid deployment of analytical models, reliability engineering, and text mining. Though the SEP 102, pain points in service operations are diagnosed, and optimization opportunities are pinpointed. The SEP 102 also enables collaborative analysis across after-market service team, service partners, sales, manufacturing, and engineering, as well as continual tracking of improvement projects.

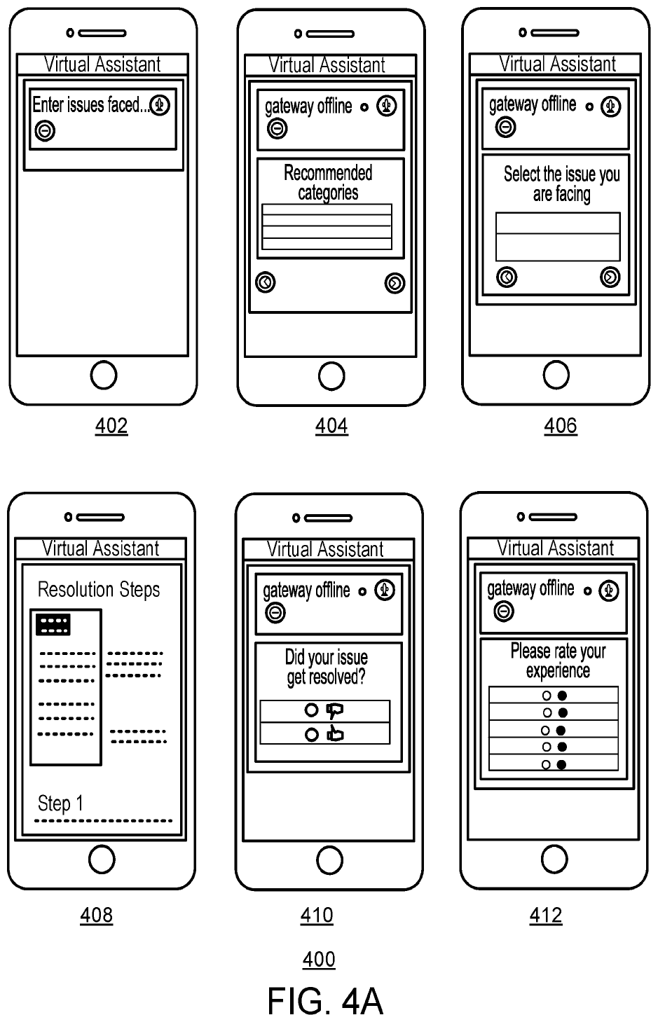

The troubleshooting mobile application 104 facilitates troubleshooting of technical queries that technicians may have on-site when servicing asset. Additionally, the troubleshooting mobile application 104 enables direct order of replacement parts from the troubleshooting mobile application 104. In an example, replacement parts can be ordered by submitting an image of the asset. Further, the troubleshooting mobile application 104 provides a form of updated technical manuals that a technician can browse. In an embodiment, the troubleshooting mobile application 104 stores field return data. As used herein, field return data includes responses from the field technicians, such as which parts they have replaced, the problems they encountered, and subsequently checked. The field return data can be used to train a chat bot based application using natural language processing/deep learning techniques. In an example, a virtual assistant decision tree guides users to an end text or video solution to their submitted troubleshooting problem as described with respect to FIG. 4 below.

Natural language processing/deep learning techniques are used to interpret natural language, including speech and text. In an example, natural language processing is a subfield of linguistics, computer science, and artificial intelligence concerned with the interactions between computers and human language. In particular, natural language processing describes how to program computers to process and analyze large amounts of natural language data. Through natural language processing, a computer system can interpret various relationships present in the contents of documents, including the contextual nuances of the language within them. Information and insights contained in the documents are accurately extracted, and the documents themselves are categorized and organized. For example, the natural language processing can be used to extract issue/resolution pairs across one or more documents. As used herein, an issue is a malfunction or other poor working condition associated with an asset. A resolution is at least one corrective action that is executed to correct or eliminate an identified malfunction or other poor working condition associated with an asset. In an embodiment, issue/resolution pairs describe problems associated with the asset and one or more techniques used to remedy the problems.

Accordingly, the troubleshooting mobile application 104 takes as input a number of resources to be used to support troubleshooting functionality. In the example of FIG. 1, the troubleshooting mobile application 104 has as inputs manuals 130, decision tree authoring 132, product image library 134, and exploded view technical diagrams and bill of materials (BOMs) 136. In the example of FIG. 1, the service call prioritization information 118 from the service excellence application portal is provided as input to the troubleshooting mobile application 140, and rendered at the troubleshooting mobile application dashboard 146.

In an embodiment, the manuals 130 are parsed and stored for use by the troubleshooting mobile application 140. As used herein, a manual is a document associated with an industrial asset. Manuals may be captured in a portable document format (PDF). The manual includes details regarding the functionality of the asset. In an example, the manual is a technical specification associated with the asset. Manuals associated with industrial assets may be unavailable from the author in digital format. Accordingly, the manuals are scanned into a digital format and parsed. In an embodiment, parsing the manual includes categorizing text of the manual in one or more issue/resolution pairs. A technician can access the digitized and stored manuals 130 through the troubleshooting mobile application 140. For example, when a technician is on site servicing an asset, the technician can access the troubleshooting mobile application 140 to resolve the issue. In an example, the troubleshooting mobile application 140 can search the manuals 130 so that when the technician is looking for a resolution, the issue/resolution pairs provide pointed answers to the issues the field person might be facing. In an embodiment, the issue/resolution pairs are obtained from the manual. In an embodiment, the issue/resolution pairs are generated when the manual is parsed and updated by other technicians on the fly. Decision tree authoring 132 is accessed through the troubleshooting web application 140 and enables information updates associated with an asset with a troubleshooting workflow. In an example, the information update authorization is accessible to an administrator of the troubleshooting web application 140. In an embodiment, an administrator is one or more persons who are responsible for the upkeep, configuration, and reliable operation of computer systems. Technicians can request additional updates to information associated with an asset. The final decision to update information is at the discretion of the administrator. In an embodiment, the decision tree authoring 132 is a virtual assistant authoring tool. The decision tree authoring 132 enables the generation of dynamic troubleshooting workflows on the fly, in real-time. The decision tree authoring may guide users to an end text or video solution to their submitted troubleshooting problem. In an embodiment, a technician characterizes a workflow by a duration, category, question, resolution, and any other associated data such as audio, video, or images. This information is submitted to update a backend architecture populating the troubleshooting mobile application 140. In an embodiment, the backend architecture includes a code that runs on a server, requests from the clients, and contains logic to send the appropriate data back to the client. The back-end also includes a database that persistently stores all of the data associated with the troubleshooting application.

In an example, an administrator can author a decision-making workflow so that technicians who encounter the same issue have access to the previously authored workflow. The most frequent resolution steps selected by technicians (facing similar issues) are prioritized automatically by the tool. This workflow is stored for later access by the troubleshooting mobile application 140. In this manner, the present techniques enable the extraction of issue/resolution pairs from technical manuals associated with industrial assets. Further, the present techniques update technical manuals associated with industrial assets with issue/resolution pairs. In an embodiment, the present techniques capture issue and resolution pairs, and also link the pairs to associated technical documentation. The present techniques create a historical record that is dynamic and can be updated so that all technicians across all sites have access to the same updated data.

In the example of FIG. 1, a product image library 134 stores one or more images associated with an industrial asset. The troubleshooting mobile application 104 includes an image to the product page ordering (product ID) 142. Using images available in the product image library 134, products can be ordered by selecting the product image within the troubleshooting mobile application. The image to the product page ordering (product ID) 142 includes a deep-learning image classification model. The deep-learning image classification model takes as input a product image and returns a link to that identified product's ordering page. This facilitates quick, on site ordering placed by technicians. In an embodiment, image classification takes an input an image and outputs a probability that the input belongs to a particular class. For example, the input image is an asset or a component of an asset, and image classification is used to determine a probability that the asset or asset component belongs to a particular category. In an embodiment, the classification or category is associated with an ordering tool, where the asset, asset component, or other associated components are ordered.

In the example of FIG. 1, a two-dimensional (2D) to scalable vector graphics (SVG) model conversion 144 is illustrated. The 2D to SVG model conversion 144 takes as input exploded view technical diagrams/BOMs 136. In an embodiment, the exploded technical view diagrams are in a file format that enables the exploded view labels to be hyperlinked to product pages. For example, the exploded view technical diagrams/BOMs 136 are PDF files. In an embodiment, the 2D to SVG model conversion 144 is a machine learning modeling process that converts PDF document diagrams to SVG files. This enables the user to click a specific part in a manual and find its detailed web ordering page. This approach uses a custom-trained neural network and optical character recognition to locate and identify labels in diagrams and bill of material tables.

For example, in the technical manuals exploded view diagrams illustrate the technical details of different assets. The object detection models identify the labels on the exploded view diagrams when the PDFs are ingested. In an embodiment, the present techniques use optical character recognition to identify part numbers of each component in a PDF assembly drawing and converts the identified digits into a hyperlink. In an embodiment, object detection identifies and labels one or more assets in an image, counts the assets in the image, and determines and tracks the precise locations of the assets. The labels on the exploded view diagrams would be turned into hyperlinks enabling the technician to click on a part that is labeled in the diagram in the manual, view it on the troubleshooting dashboard 146, and go from the ordering page right to the manual. In an embodiment, when ingesting the PDF, adjustments that are done including converting the PDF file to a nested data structure, such as javascript object notation (JSON).

In the example of FIG. 1, functions described with respect to the troubleshooting mobile application 140, the image to product page ordering (product ID) 142, and the 2D to SVG model conversion 144 are rendered by the troubleshooting dashboard 146. The troubleshooting dashboard 146 also renders service call prioritization information 118 from the service excellence application portal 102. In the example of FIG. 1, the troubleshooting mobile application 104 enables expedited service technician assistance 150 and product ID facilitated ordering 152. The troubleshooting mobile application 104 can also output technician/asset status information 154. Each of the expedited service technician assistance 150, product ID facilitated ordering 152, and technician/asset status information 154 are input and rendered at the extended warranty pricing dashboard 120. The extended pricing warranty dashboard 120 of the service excellence application portal 102 outputs optimized warranty pricing strategies 122.

Although particular sources of data have been described, the present techniques can incorporate a variety of data related to the asset. For example, the different sources of data include an aftermarket spare parts sales history, asset base (location, install date, appointment serial number), service history (warranty data from internal systems, work orders from servicers, dealers, and customers service shops or other fields service systems logs), technical manuals (troubleshooting guides, product manuals, FAQ pages), product information (bill of material, CAD data), and in-service conversations (online chat bot, clicking on self-serve frequently asked question (FAQ) pages, audiovisual logs, phone logs), and IOT/usage logs.

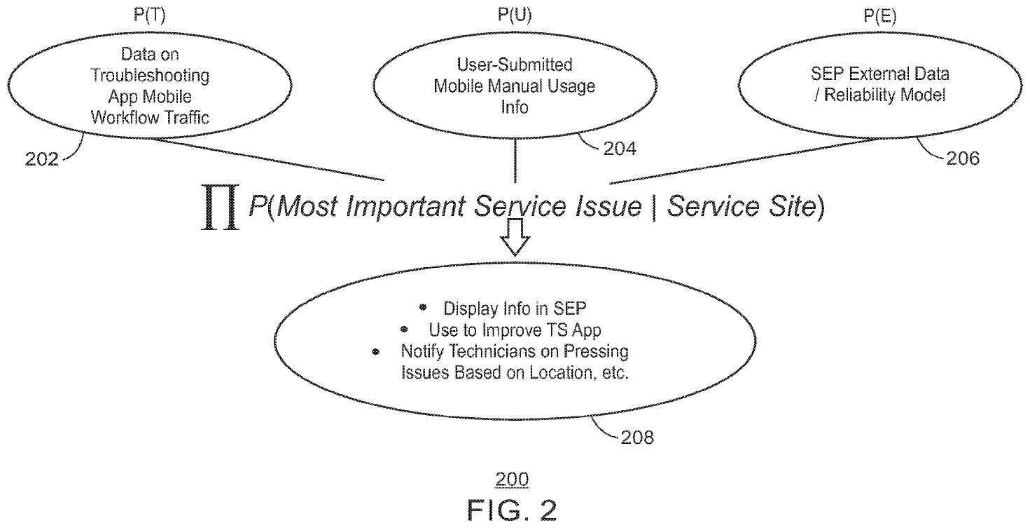

In an embodiment, the troubleshooting mobile application 104 is a decision tree that takes the user from an input (either spoken word or a typed query) through a decision workflow to an end resolution page that gives more information on how to solve whatever technical queries they're working on. The administrator also has access to an authoring application (e.g., decision tree authoring 132) that enables dynamic generation of workflows, in real time. Deep learning image classification is used to identify the submitted images of product and return the user to that product ordering page. In an embodiment, a user uploads a PDF manual that is parsed. During parsing, the manual is ingested, wherein ingesting the manual comprises transforming the manual into one or more additional formats. In this manner, technicians can browse through the manuals when they are on call (e.g., at a service site with the expectation of restoring functionality to an asset). In an embodiment, the troubleshooting mobile application collects information on asset health from the technicians. This information can be used to improve the service excellence portal. In an embodiment, the troubleshooting mobile application can determine what would be the most pressing technical issue at that site that the technician should bring attention to given the user's location as described with respect to FIG. 2.

In an embodiment, the system 100 includes additional reliability/prediction outputs, such as reliability and cycle time based predictive maintenance alerts, install base updated with predictive maintenance based alerts, usage-based extended warranty/service contract pricing tool, end-of-life prediction, output pertaining to the first time fix-start up-preventative maintenance, and age-based reliability profiles. In an embodiment, the system 100 includes a service tracking dashboard and fleet monitoring dashboard for monitoring of the assets. In an embodiment, a sales dashboard is output that includes consumable replenishment orders and parts entitlements. Further, a product dashboard outputs spares inventory and engineering updates for products quality improvements. A servicing dashboard outputs claim authorizations, supply recovery lists, field service technician picklists for maintenance, field technician optimal placement recommendations, and optimized consumable and servicing plans.

The present techniques are adaptive based on an aftermarket service process digitization matrix. Additional inputs can be added to the workflow to optimize warranty pricing strategies. The input can be any document that has anything useful that can be input to the troubleshooting mobile application. For example, companies often have physical manuals associated with pieces of equipment, wherein the physical manuals are old, outdated, with no new documentation being produced. The present techniques can be used to parse the manuals and create updates to the manuals.

The block diagram of FIG. 1 is not intended to indicate that the system 100 is to include all of the components shown in FIG. 1. Rather, the system 100 can include fewer or additional components not illustrated in FIG. 1 (e.g., additional data inputs, asset sites, asset predictions, views, strategies and the like). The system 100 may include any number of additional components not shown, depending on the details of the specific implementation. Furthermore, any of the survival analysis and assets at risk dashboards 114, extended warranty pricing dashboards 120, troubleshooting mobile application 140, image to product page ordering (product ID) 142, and 2D to SVG model conversion may be partially, or entirely, implemented in hardware and/or in a processor. For example, the functionality may be implemented with an application specific integrated circuit, in logic implemented in a processor, in logic implemented in a specialized graphics processing unit, or in any other device.

### Troubleshooting Workflow Traffic

FIG. 2 is an example of a Bayesian network 200 that determines a most important service issue according to the present techniques. Companies often spend significant resources on addressing service concerns of one or more assets. The present techniques use existing and newly collected service-related data to mathematically calculate the best extended warranty pricing strategies, given a specific company's fleet of products in use. The present techniques enable continual monitoring of these assets and more efficient service calls by technicians using the troubleshooting mobile application. In the example of FIG. 2, the present techniques determine a most pressing service issue at a service site.

In an embodiment, the Bayesian network 200 is a component of a troubleshooting mobile app (e.g., troubleshooting mobile app 104). The network 200 determines a joint probability of a most important service issue for service sites 208. The joint probability 208 is based on data on troubleshooting app mobile workflow traffic 202, user submitted mobile manual usage info 204, and survivability/reliability data 206. In an embodiment, the survivability/reliability data 206 is obtained from the SEP (e.g., SEP 102). The network 200 determines, given a technician's geographic location, the most pressing service issue the technician should prioritize. This takes information from the reliability models in the service excellence portal, user-submitted information on mobile technical manual usage, as well as traffic data from the app itself to make this determination. For example, if a new technician is dispatched to service a site after another technician has been onsite, the present techniques ensure that the new technician is notified of all troubleshooting workflows executed by the previous technician. In an embodiment, the new technician is notified of all troubleshooting workflows executed by the previous technician using data from the troubleshooting mobile app

The output of the Bayesian network 200 is a probability of an issue being a most important service issue at a service site. In an embodiment, the probability of an issue being a most important service issue at a service site is rendered by the troubleshooting mobile application and the service excellence portal. In an embodiment, the probability of an issue being a most important service issue at a service site is used to trigger a notification to technicians based on location. For example, a technician within a predetermined distance from the location that has the issue may be notified.

The present techniques enable an amalgamation of different capabilities associated with servicing an asset. The workflow according to the present techniques is flexible. Additionally, the present techniques can ingest multiple forms of data associated with an industrial asset, and can adjust to whatever data is available and can be adapted to extract some value service wise. Accordingly, the present techniques adaptively support troubleshooting of an industrial asset based on available asset data. In an example, the present techniques store the data on troubleshooting app mobile workflow traffic 202 and survivability/reliability data 206 to calculate a probability of failures a predetermined time period. In an embodiment, this information is used as an alert for the fleet manager to plan for future dispatch of technicians to service assets predicted to fail within the predetermined time period.

The present techniques include a knowledge repository that includes parsed technical manuals and field returns from technicians, such as user submitted mobile manual usage info 204. Traditional technical manuals are static and unable to be updated on the fly. However, the present techniques enable a form of real-time updates to the technical manuals. In an embodiment, multiple users across distinct geographic locations can benefit from this information. For example, the present techniques include a network-based approach the most pressing issue at a particular site is determined using the survivability/reliability based model. Accordingly, the present techniques enable a conglomeration of data into an alert so the end-users can be notified appropriately and on a timely basis.

FIG. 2 is not intended to indicate that the network 200 is to include all of the components shown in FIG. 2. Rather, the network 200 can include fewer or additional components not illustrated in FIG. 2 (e.g., additional data inputs, outputs, and the like). The network 200 may include any number of additional components not shown, depending on the details of the specific implementation. Furthermore, any of the functionality described with respect to the network 200 may be partially, or entirely, implemented in hardware and/or in a processor. For example, the functionality may be implemented with an application specific integrated circuit, in logic implemented in a processor, in logic implemented in a specialized graphics processing unit, or in any other device.

### Service Excellence Portal

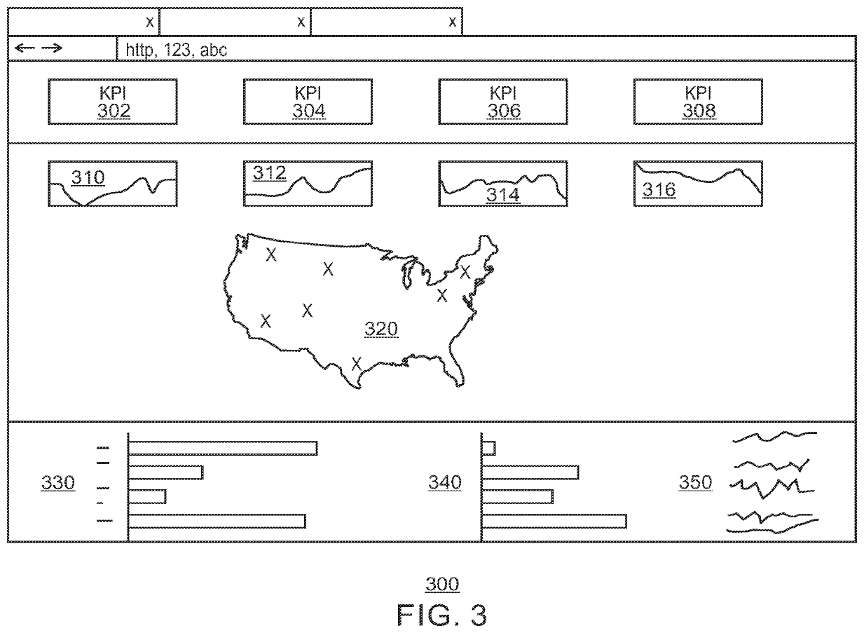

FIG. 3 is an example of a page 300 of the service excellence portal. In embodiments, the page 300 is a landing page of the service excellence portal 300. In an embodiment, the landing page 300 illustrates at a glance a quick recapitulation (recap) of key performance indicators (KPIs) associated with one or more assets. As illustrated, the example page 300 includes a KPI 302, a KPI 304, a KPI 306, and a KPI 308. As used herein, a KPI may be an incident rate, total job cost, cost per unit, cost per incident, or any combinations thereof. Moreover, KPIs may be an average number of failures per year, mean time between failures, common preventative maintenance schedules, corrective maintenance, preventative/corrective maintenance correlation, life expectancy, device age and retirement information. Further, other KPIs are top categories in terms of customers, in terms of problem codes (e.g., what are the number of incidents), an incident rate, and a monthly KPI trend.

One or more trend lines are rendered on the page 300. Accordingly, in the example of FIG. 3, a trend line 310, trend line 312, trend line 314, and trend line 316 are illustrated. In an embodiment, a trend line is associated with one or more KPIs. For example, a trend line is a visual representation of the performance of one or more KPIs over a predetermined time period. The page 300 may also provide a geographic view 320 of the assets at risk. In an embodiment, the assets at risk are identified by location markings on a geographic map. The geographic view is a visual representation of assets at risk across a geographic area. In an embodiment, the page 300 includes a smart search feature where survivability/reliability models are specific to each region. Accordingly, the geographic view 320 is modified according to a particular region being analyzed.

In an embodiment, some key parameter indices (KPIs) are illustrated in graph format. For example, the page 300 includes a KPI 330 in bar graph format, a KPI 340 in bar graph format, and a KPI 350 in line graph format. Additionally, in an embodiment assets at highest risk are associated with additional information in the service excellence portal. In an embodiment, this additional information is rendered in the service excellence portal. For example, the additional information may be rendered on a webpage of the service excellence portal. In embodiments, this group of assets is classified according to one or more severity levels. For example, the severity levels may be higher according to a likelihood of failing. For each asset, data is available such as what was the last problem code, failure at that particular site, and what is the survival score for the next 30 days (duration can vary), and the characteristic life (what is the typical duration of failure of other similar assets from the particular region), what is the total warranty cost incurred per date at the current site, a net composite score (which help create severity clusters of the service excellence portal). The survivability score represents the likelihood of survival in the coming X number of days. The survivability score spans from 0 to 1. A score of one would indicate that in the coming X number of days the chance of surviving is 100%. In an embodiment, the number of days is variable, depending on the user. In an embodiment, the KPIs assist a fleet manager in planning ahead for dispatching technicians to various locations.

The service excellence portal may also render warranty coverage metrics, such as extended warranty pricing options. In an embodiment, extended warranty pricing options are based on categorizing assets that are performing better compared to the population. This group of assets is classified according to one or more performance levels. Data on asset performance is used, at least in part, to determine the asset owners who would likely accept an extended warranty pricing option to assist the asset owners maintain their assets beyond the regular warranty process. In particular, a recommendation to target customers with healthier assets enables maximum profit margin when selling extending warranty service contracts. This is based an assumption that the assets which have survived or are well maintained are historically less likely to fail during the warranty period. Hence, the overall intervention or service cost to original equipment manufacturers would be less. For example, the data on asset performance may be used to determine the performance levels that have encountered the least number of failures historically and the total warranty cost per unit has been relatively low. The set of customers for asset owners would most likely be willing to accept the extended warranty pricing option. Additional data to assist in evaluating high-performing assets include independent covariant (or causalities) such as for the past number of incidents at the particular site, or for the asset; how many days since the last failure. A target warranty duration, number of incidents, and survival probabilities.

Accordingly, in an example, the service excellence portal presents an overall dashboard showing KPIs. The KPIs can include incident rate, total job cost across all assets, cost per unit, and cost per incident. The service excellence portal can render a map of assets and the KPIs broken down by area, job system, and category. The service excellence portal includes monitoring of high-risk assets. For monitoring high-risk assets, the numbers of assets in each risk category are displayed, along with a map and table details of those that are highest risk. The service excellence portal also enables an extended warranty pricing model. In an embodiment, the extended warranty model renders preference levels of assets when computed by an extended warranty pricing model. A table of details on survival for each asset and a cost distribution plot by region is also rendered via the extended warrant model. Similarly, extended warranty historical data can be used to calculate the survivability of assets. In an embodiment, the service excellence portal renders a forecasted warranty cost that includes a table and map of assets by region with the range of projected warranty costs. In an embodiment, standard pricing problem code renders one or more problem codes from an asset, the recommended costs for those codes in a table, a map, a Paynter chart showing the frequency of the codes, and a cost distribution plot. In an embodiment, the service excellence portal provides asset level dynamic warranty pricing. An asset level dynamic warranty pricing, additional information (variables or information discussed above) can be modified to show its impact on warranty pricing per asset. For example, a user can observe the impact of future changes associated with the asset on warranty pricing.

The present techniques use data output by the service excellence portal as input to the trouble shooting mobile app. In particular, data output by the service excellence portal may be used to update the knowledge stored by the troubleshooting mobile application inputs. The service excellence portal captures field returns and other warranty data. The inclusion of the service excellence portal with troubleshooting mobile application inputs creates a closed loop system where real world information associated with each asset is captured and analyzed, and used for updates as necessary.

FIG. 3 is not intended to indicate that the page 300 is to include all of the components shown in FIG. 3. Rather, the page 300 can include fewer or additional components not illustrated in FIG. 3 (e.g., additional pages, KPIs, views, trends, and the like). The page 300 may include any number of additional components not shown, depending on the details of the specific implementation. Furthermore, any of the functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### Troubleshooting Mobile Application

FIG. 4 is a series of screenshots from the troubleshooting mobile application. The series of screenshots is exemplary in nature and should not be viewed as limiting. The series of screenshots may include more or less screenshots than those provided in the example herein. Additionally, the troubleshooting mobile app may present more or less information than that provided in the example of FIG. 4.

In the example of FIG. 4, a prompt is given at a screenshot 402. A user is guided through a decision workflow structure to reach a resolution at a screenshot 408. In an embodiment, the user is a service technician. A query is submitted at screenshot 404. In the example of screenshot 404 provided, the query is “gateway off-line.” In the screenshot 404, the user can also select one or more recommended categories. In this example, the gateway being a fuel dispenser. Accordingly, the category “fuel dispenser” is selected. Submitting the query results in screenshot 406, where further information is requested from the user. In particular, the user is asked to “select the issue you are facing.” In an embodiment, one or more follow-up questions may be presented to the user to arrive at a resolution.

The screenshot 408 provides a resolution with steps for the user to resolve the issue. In an embodiment, the resolution page may be populated with media, such as images or videos. The technician follows the resolution steps to solve the identified issue. In some cases, technician feedback is captured. Accordingly, screenshot 410 prompts the technician to provide feedback. The feedback includes a feedback loop through which the different tools in the suite strengthen each other. In particular, the screenshot 410 asks as if the issue was resolved. Screenshot 412 asks the technician to rate the experience. In an embodiment, a field technician uses the troubleshooting mobile application on site.

In the description immediately above, the inputs and outputs to the troubleshooting mobile app may be through touch input of the device. Inputs and outputs may also be visual. In an example, a user can capture images of field data for further analysis by the troubleshooting mobile app. Similarly, the troubleshooting mobile app can output images and other data for the user, the user can also speak the queries into the troubleshooting mobile app. For example, using a spoken word query as input, a natural language processing model searches for the query in the database of decision workflows.

### After-Market Service Process Digitization

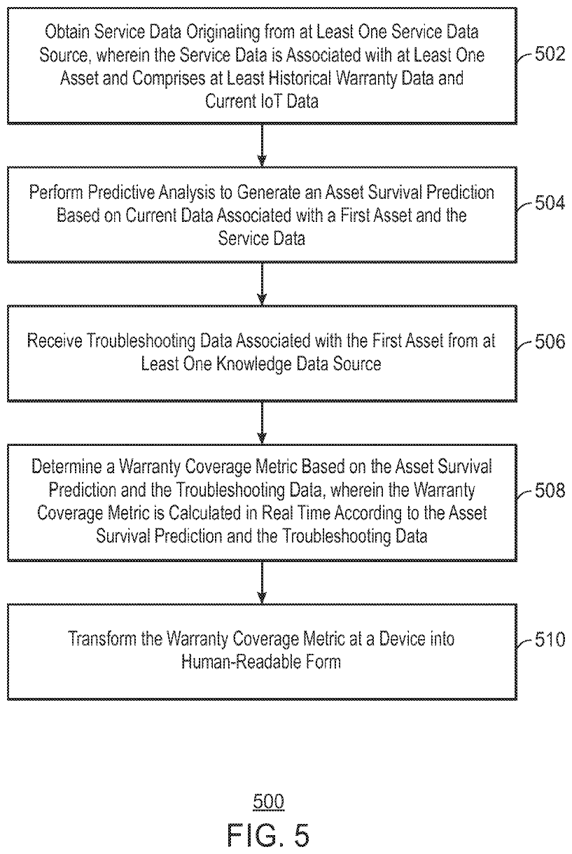

FIG. 5 is a process flow diagram of a process for an after-market service process digitization. The example process 500 can be implemented by the system 100 of FIG. 1.

At block 502, service data is obtained obtaining, by at least one processor, service data originating from at least one service data source wherein the service data is associated with at least one asset and comprises at least historical warranty data and current IoT data. In an embodiment, service data is measurements or data associated with the ongoing maintenance, repair, monitoring, or upgrading of industrial assets. In an embodiment, a service data source is historical warranty data; current IOT data, and the like. In an embodiment, the at least one asset is various equipment that support operations in any number of industries. In an embodiment, historical warranty data is historic data for entire fleet. In an embodiment, current IOT data is current data for assets across the fleets of a plurality of companies.

At block 504, predictive analysis is performed to generate an asset survival prediction based on current data associated with a first asset and the service data. In an embodiment, current data is current service data of an asset.

At block 506, troubleshooting data is received associated with the first asset from at least one knowledge data source. In an embodiment, troubleshooting data is asset health, technician actions, or ordered products for replacement from the troubleshooting mobile app. In an embodiment, the at least one knowledge data source is a troubleshooting mobile application, including an authoring tool, library, manuals, and other historic data associated with any issues indicated by the current data of the asset.

At block 508, a warranty coverage metric is determined based on the asset survival prediction and the troubleshooting data, wherein the warranty coverage metric is calculated in real time according to the asset survival prediction and the troubleshooting data. In an embodiment, the warranty coverage metric quantifies the function of warranting the asset.

At block 510, the warranty coverage metric in transformed into human-readable form. In an embodiment, the warranty coverage metric includes warranty costs or warranty pricing strategies. The can be rendered at a device, such as a display, printer, or any audio/visual output device.

The present techniques combine field returns with a survivability/reliability based analysis to calculate a probability of failures. One or more alerts is based on the probabilities. In an example, the alert triggers a determination of how, where, and when to dispatch one or more technicians for servicing of an industrial asset. The present techniques include a knowledge repository processed using natural language processing, and machine learning techniques. The present techniques enable a form of real-time updates to the technical manuals. In an embodiment, multiple users across distinct geographic locations can benefit from this information. The present techniques include a network-based approach where the most pressing issue at a particular site is updated using the survivability/reliability based model. This is essentially the most complicated piece in the entire workflow.

The process flow diagram of FIG. 5 is not intended to indicate that the blocks of the example process 500 are to be executed in any order, or that all of the blocks are to be included in every case. Further, any number of additional blocks not shown may be included within the example process 500, depending on the details of the specific implementation.

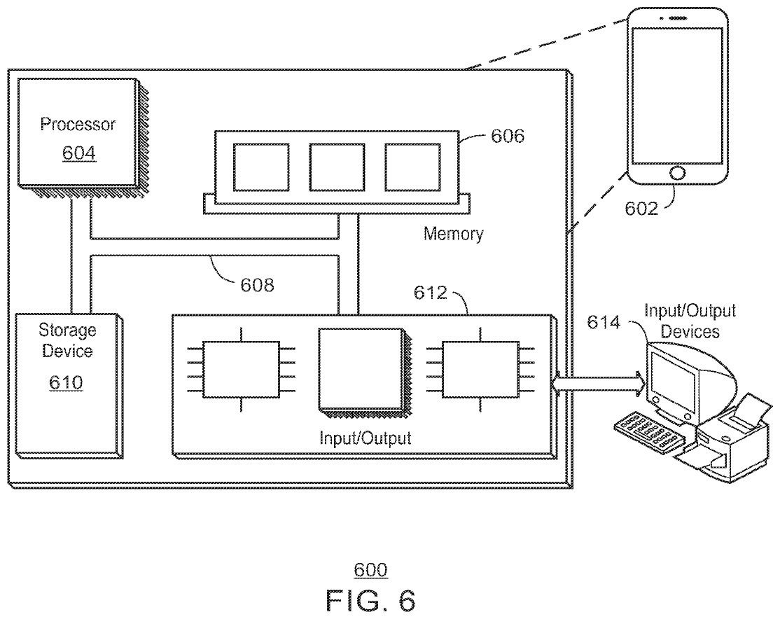

FIG. 6 is a block diagram of an example computer system 600. For example, system 100 of FIG. 1 could be a part of an example of the system 600 described here. The system 600 includes a processor 604, a memory 606, a storage device 610, and one or more input/output device interfaces 612. Each of the components 604, 606, 610, and 612 can be interconnected, for example, using a system bus 650.

The processor 604 is capable of processing instructions for execution within the system 600. The term “execution” as used here refers to a technique in which program code causes a processor to carry out one or more processor instructions. The processor 604 is capable of processing instructions stored in the memory 606 or on the storage device 610. The processor 604 may execute operations such after-market service process digitization. The memory 606 stores information within the system 600. In some implementations, the memory 606 is a computer-readable medium. In some implementations, the memory 606 is a volatile memory unit. In some implementations, the memory 606 is a non-volatile memory unit.

The storage device 610 is capable of providing mass storage for the system 600. In some implementations, the storage device 610 is a non-transitory computer-readable medium. In various different implementations, the storage device 610 can include, for example, a hard disk device, an optical disk device, a solid-state drive, a flash drive, magnetic tape, or some other large capacity storage device. In some implementations, the storage device 610 may be a cloud storage device, e.g., a logical storage device including one or more physical storage devices distributed on a network and accessed using a network. In some examples, the storage device may store long-term data, such as technician profiles, asset profiles, location specific data, and the like. The input/output interface devices 640 provide input/output operations for the system 600. In some implementations, the input/output interface devices 640 can include one or more of a network interface devices, e.g., an Ethernet interface, a serial communication device, e.g., an RS-232 interface, and/or a wireless interface device, e.g., an 602.11 interface, a 3G wireless modem, a 6G wireless modem, etc. A network interface device allows the system 600 to communicate, for example, transmit and receive such data. In some implementations, the input/output device can include driver devices configured to receive input data and send output data to other input/output devices, e.g., keyboard, printer and display devices 660. In some implementations, mobile computing devices, mobile communication devices, and other devices can be used.

A server or database system 602 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 600 is contained within a single integrated circuit package. A system 600 of this kind, in which both a processor 604 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 612.

Although an example processing system has been described in FIG. 6, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as control of service process digitization, model training, and model execution can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

A number of embodiments of the invention have been described. Nevertheless, it will be understood that various modifications may be made without departing from the spirit and scope of the invention.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
obtaining, by at least one processor, service data, originating from at least one service data source, wherein the service data is associated with at least one asset and comprises at least historical warranty data and current IoT data;
performing, using at the least one processor, predictive analysis to generate an asset survival prediction based on current data associated with a first asset and the service data;
receiving, using the least one processor, troubleshooting data associated with the first asset from at least one knowledge data source;
determining, using the at least one processor, a warranty coverage metric based on the asset survival prediction and the troubleshooting data, wherein the warranty coverage metric is calculated in real time according to the asset survival prediction and the troubleshooting data; and
transforming, using the at least one processor, the warranty coverage metric at a device into human-readable form.

2. The method of claim 1, wherein the service data includes data associated with asset health of an entity.

3. The method of claim 1, wherein performing the predictive analysis is based on, at least in part, feedback associated with the troubleshooting data.

4. The method of claim 1, wherein the predictive analysis comprises survivability modeling.

5. The method of claim 1, wherein the at least one knowledge data source is a virtual assistant decision tree.

6. The method of claim 1, wherein the at least one knowledge data source is a deep-learning image classification model or a machine learning classification model.

7. The method of claim 1, wherein the warranty coverage metric is a warranty pricing strategy.

8. The method of claim 1, wherein the asset survival prediction is a Weibull distribution, Kaplan-Meier (KM) estimator, Cox-proportional hazard model, or Random Survival Forest model.

9. A system, comprising:
at least one processor; and
at least one memory storing instructions thereon that, when executed by the at least one processor, cause the at least one processor to:
obtain service data originating from at least one service data source, wherein the service data is associated with at least one asset and comprises at least historical warranty data and current IoT data;
perform predictive analysis to generate an asset survival prediction based on current data associated with a first asset and the service data;
receive troubleshooting data associated with the first asset from at least one knowledge data source;
determine a warranty coverage metric based on the asset survival prediction and the troubleshooting data, wherein the warranty coverage metric is calculated in real time according to the asset survival prediction and the troubleshooting data; and
transform the warranty coverage metric at a device into human-readable form.

10. The system of claim 9, wherein the service data includes data associated with asset health of an entity.

11. The system of claim 9, wherein performing the predictive analysis is based on, at least in part, feedback associated with the troubleshooting data.

12. The system of claim 9, wherein the predictive analysis comprises survivability modeling.

13. The system of claim 9, wherein the at least one knowledge data source is a virtual assistant decision tree.

14. The system of claim 9, wherein the at least one knowledge data source is a deep-learning image classification model.

15. A non-transitory computer-readable storage medium comprising at least one program for execution by at least one processor of a first device, the at least one program including instructions which, when executed by the at least one processor, carry out a method comprising:
obtain service data originating from at least one service data source, wherein the service data is associated with at least one asset and comprises at least historical warranty data and current IoT data;
perform predictive analysis to generate an asset survival prediction based on current data associated with a first asset and the service data;
receive troubleshooting data associated with the first asset from at least one knowledge data source;
determine a warranty coverage metric based on the asset survival prediction and the troubleshooting data, wherein the warranty coverage metric is calculated in real time according to the asset survival prediction and the troubleshooting data; and
transform the warranty coverage metric at a device into human-readable form.

16. The computer-readable storage medium of claim 15, wherein the service data includes data associated with asset health of an entity.

17. The computer-readable storage medium of claim 15, wherein performing the predictive analysis is based on, at least in part, feedback associated with the troubleshooting data.

18. The computer-readable storage medium of claim 15, wherein the predictive analysis comprises survivability modeling.

19. The computer-readable storage medium of claim 15, wherein the at least one knowledge data source is a virtual assistant decision tree.

20. The computer-readable storage medium of claim 15, wherein the at least one knowledge data source is a deep-learning image classification model.

21. A method, comprising:
obtaining, using at least one processor, at least one exploded technical view diagram associated with an asset; and
inputting, using the at least one processor, the at least one exploded technical view diagram to a machine learning model that is trained to output a scalable vector graphics model corresponding to the at least one exploded technical view diagram, wherein an exploded view label in the scalable vector graphics model is hyperlinked to a product page.

22. The method of claim 1, wherein the machine learning model is trained using identified labels in training exploded technical view diagrams.

23. The method of claim 1, wherein optical character recognition is used to identify part numbers in the at least one exploded technical view diagram, and digits of the part numbers are converted to a hyperlink to the product page.

24. The method of claim 1, wherein the product page is viewed using a troubleshooting mobile application.
